(19) United States
(12) Patent Application Publication
(10) Pub. No.: US 2007/0299655 A1
(43) Pub. Date: Dec. 27, 2007

(54) Method, Apparatus and Computer Program Product for Providing Low Frequency Expansion of Speech

(75) Inventors: Laura Laaksonen, Espoo (FI); Jarmo Hiipakka, Espoo (FI); Ville Myllyla, Tampere (FI); Kalle I. Makinen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/425,809

(22) Filed: Jun. 22, 2006

(51) Int. Cl. G10L 19/14

(52) U.S. Cl. 704/205

(57) ABSTRACT

An apparatus for providing low frequency expansion of speech includes a nonlinear function element, a band-pass filter element and a level control element. The non-linear function element is configured to receive a signal including at least two harmonic components and to produce a signal including at least one lower frequency harmonic component having a lower frequency than a highest frequency component of the at least two harmonic components responsive to the signal including at least two harmonic components. The band-pass filter element is in communication with the non-linear function element and configured to filter the signal including the at least one lower frequency harmonic component. The level control element is configured to apply a level control to alter the filtered signal based on a feature vector associated with an input speech signal.

### TECHNOLOGICAL FIELD

Embodiments of the present invention relate generally to speech signal quality, and, more particularly, relate to a method, apparatus, and computer program product for providing a low frequency expansion technique for speech signals.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase convenience to users involves the provision of improved sound quality regarding audio signals, such as speech signals, which are received at terminals such as mobile or fixed telephones. Current sound quality suffers due to a mismatch between the bandwidth of human speech and the bandwidth capabilities of conventional telephones. For example, conventional telephone bandwidths, such as for global system for mobile communications (GSM) and landline phones, are limited to a narrowband frequency range of about 300 Hz to about 3400 Hz. Meanwhile, human speech contains frequencies in a range from about 50 Hz to 10 kHz. The mismatch essentially means that large portions of the frequencies that make up human speech are lost during transmission via, for example, landline or GSM telephones. Thus, speech quality is reduced, which often makes telephonic communications difficult to understand.

Human speech production can be modeled with a source-filter model. The source-filter model includes an excitation signal and a filter that shapes a spectral envelope of the excitation. When a human voice is utilized to create human speech, an excitation signal is created in the larynx as the vocal chords vibrate at a certain frequency. The frequency is the fundamental frequency of speech and is perceived as a pitch. A spectrum of the excitation signal includes the fundamental frequency and a plurality of harmonics of the fundamental frequency, which occur at integer multiples of the fundamental frequency. The vocal track then acts as a time-varying acoustic filter which shapes an envelope of the excitation signal and thus contributes to the perceived phoneme. An exemplary spectrum of a human voice is presented in FIG. 1. The harmonic structure is well preserved in low frequencies and the lowest peak in the spectrum is the fundamental frequency f₀. Harmonic components are for example, the zeroth harmonica fₒ, the first harmonic f₁=2fₒ, the second harmonic f₂=3fₒ, etc. FIG. 2 illustrates spectra for an original wideband voice signal, a narrowband signal via conventional GSM, and a narrowband signal via a conventional landline. As shown in FIG. 2, each of the above signals are relatively consistent within the narrowband frequency range of about 300 Hz to about 3400 kHz, but the original wideband voice signal varies significantly from the narrowband signal via conventional GSM, and the narrowband signal via a conventional landline outside of the narrowband frequency range.

In order to improve the quality of human speech signals, efforts have been made to expand the upper cutoff frequency (i.e., 3400 Hz) of conventional telephone networks. Using, for example, a method called artificial bandwidth expansion, the upper cutoff frequency may be expanded up to about 7 or 8 kHz. Artificial bandwidth expansion may be performed by recreating missing high frequencies (i.e., the frequencies above 3400 Hz that would otherwise be lost) in the receiving end of a transmission chain. Alternatively, a true wideband transmission may be performed in which the missing high frequencies are transmitted along with information in the narrowband frequency range.

However, the above described and other methods of artificial bandwidth expansion fail to account for the missing low-frequency components (i.e., frequencies below 300 Hz). Furthermore, the methods of performing high frequency expansion of speech are not applicable to low frequencies. The result is a more highly resolved speech signal in terms of high frequencies, without a balancing increase in resolution for low frequencies. Thus, a tinny sounding speech signal may be produced. In the past, low frequencies were simply filtered out by a high-pass filter since speaker elements were often limited in performance at the low frequencies. However, a variety of currently available speaker elements provide the possibility of reproducing frequencies below 300 Hz. Accordingly, there is a need to provide for a technique for low-frequency expansion of speech signals.

### BRIEF SUMMARY

A method, apparatus and computer program product are therefore provided as a technique for low-frequency expansion of speech signals. In particular, a method, apparatus and computer program product are provided that employ a non-linear function to improve the quality of a narrowband speech signal by expanding a spectra of the narrowband speech signal toward frequencies below the lower cutoff bandwidth of the narrowband speech signal. The gain of the low frequency portions of the expanded signal may then be adjusted based on a feature extracted from the narrowband speech signal. Embodiments of the present invention may also employ a downsampling (or decimation) to achieve a reduction in computational complexity of the low frequency expansion described above.

In one exemplary embodiment, a method of providing a technique for low-frequency expansion of speech signals is provided. The method includes applying a non-linear function to a signal including at least two harmonic components to produce a signal including at least one lower frequency harmonic component having a lower frequency than a highest frequency component of the at least two harmonic components and filtering the signal including the at least one lower frequency harmonic component. The method may further include applying a level control to alter the filtered signal based on a feature vector associated with an input speech signal.

In another exemplary embodiment, a computer program product for providing a technique for low-frequency expansion of speech signals is provided. The computer program product includes at least one computer-readable storage medium having computer-readable program code portions stored therein. The computer-readable program code portions include first, second and third executable portions. The first executable portion is for applying a non-linear function to a signal including at least two harmonic components to produce a signal including at least one lower frequency harmonic component having a lower frequency than a highest frequency component of the at least two harmonic components. The second executable portion is for filtering the signal including the at least one lower frequency harmonic component. The third executable portion is for applying a level control to alter the filtered signal based on a feature vector associated with an input speech signal.

In another exemplary embodiment, an apparatus for providing a technique for low-frequency expansion of speech signals is provided. The apparatus includes a nonlinear function element, a band-pass filter element and a level control element. The non-linear function element is configured to receive a signal including at least two harmonic components and to produce a signal including at least one lower frequency harmonic component having a lower frequency than a highest frequency component of the at least two harmonic components responsive to the signal including at least two harmonic components. The band-pass filter element is in communication with the non-linear function element and configured to filter the signal including the at least one lower frequency harmonic component. The level control element is configured to apply a level control to alter the filtered signal based on a feature vector associated with an input speech signal.

In another exemplary embodiment, an apparatus for providing a technique for low-frequency expansion of speech signals is provided. The apparatus includes means for applying a non-linear function to a signal including at least two harmonic components to produce a signal including at least one lower frequency harmonic component having a lower frequency than a highest frequency component of the at least two harmonic components, means for filtering the signal including the at least one lower frequency harmonic component, and means for applying a level control to alter the filtered signal based on a feature vector associated with an input speech signal.

Embodiments of the invention may provide a method, apparatus and computer program product for low-frequency expansion of speech signals, which may be advantageously employed in limited bandwidth applications such as in telephony networks including both landline and wireless applications. In this regard, embodiments of the invention may be employed in mobile terminal devices, such as mobile telephones, fixed telephone devices, or in network devices such as a server that forms an element of a telephone network. As a result, for example, clarity and quality of speech signals received at such devices may be improved. Furthermore, when used in conjunction with a high frequency expansion technique, embodiments of the present invention may provide an improved wideband representation of an original speech signal. It should be noted, however, that embodiments of the invention should not be considered as being limited to application in such devices described above.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 illustrates an exemplary spectrum of a human voice;

FIG. 2 illustrates an exemplary spectra for an original wideband voice signal, a narrowband signal via conventional GSM, and a narrowband signal via a conventional landline;

FIG. 3 is a schematic block diagram of a mobile terminal according to an exemplary embodiment of the present invention;

FIG. 4 is a schematic block diagram of a wireless communications system according to an exemplary embodiment of the present invention;

FIG. 5 is a block diagram showing a system embodying a low frequency expansion algorithm according to an exemplary embodiment of the present invention;

FIGS. 6A-D illustrate exemplary waveforms including a first filtered signal having first and second harmonics and resulting waveforms following processing by several exemplary non-linear functions according to an exemplary embodiments of the present invention;

FIG. 7 is a block diagram showing a level control element according to an exemplary embodiment of the present invention;

FIG. 8 is a block diagram showing a system embodying a low frequency expansion algorithm with direct control of filter properties according to an exemplary embodiment of the present invention;

FIG. 9 is a block diagram showing a level control element for directly controlling filter properties according to an exemplary embodiment of the present invention;

FIG. 10 is a block diagram illustrating downsampling of the input speech signal according to an exemplary embodiment of the present invention;

FIG. 11 is a block diagram illustrating downsampling of the input speech signal using a first pair of quadrature mirror filter assemblies according to an exemplary embodiment of the present invention;

FIG. 12 is a schematic diagram illustrating portions of the first pair of quadrature mirror filter assemblies in greater detail according to an exemplary embodiment of the present invention;

FIG. 13 is a block diagram showing an alternative arrangement of inputs to the level control element according to an exemplary embodiment of the present invention;

FIG. 14 is a block diagram showing an alternative arrangement of inputs to the level control element according to an exemplary embodiment of the present invention;

FIG. 15 is a block diagram illustrating downsampling of the input speech signal using a first pair of quadrature mirror filter assemblies and a second pair of quadrature mirror filter assemblies wrapped around the first pair for increasing the downsampling rate by a factor of two according to an exemplary embodiment of the present invention;

FIG. 16 is a block diagram showing an alternative arrangement of inputs to the level control element according to an exemplary embodiment of the present invention; and

FIG. 17 is a flowchart according to an exemplary method for providing low frequency expansion of an input speech signal according to an exemplary embodiment of the present invention.

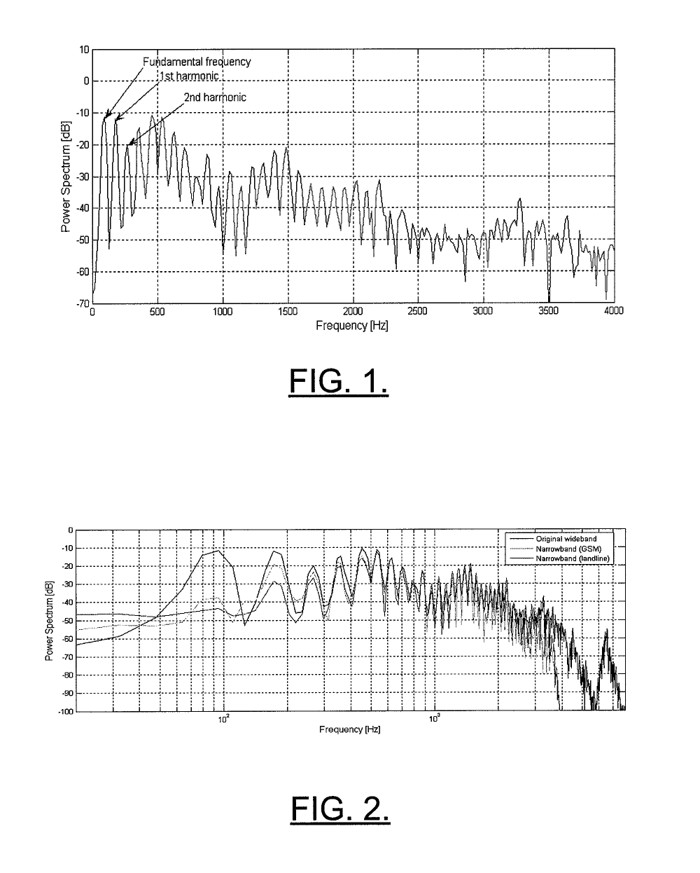

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

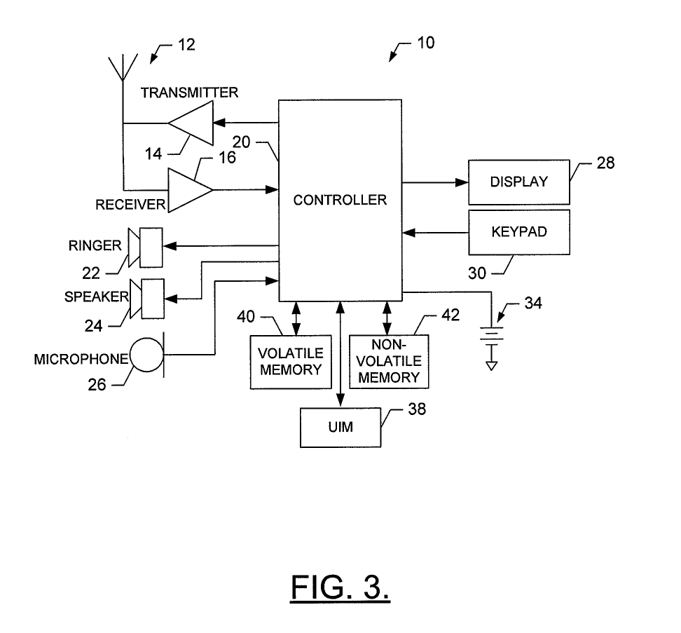

FIG. 3 illustrates a block diagram of a mobile terminal 10 that would benefit from embodiments of the present invention. It should be understood, however, that a mobile telephone as illustrated and hereinafter described is merely illustrative of one type of apparatus that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, music players, laptop computers and other types of audio, voice and text communications systems, can readily employ embodiments of the present invention. In addition to mobile devices, home appliances such as personal computers, game consoles, set-top-boxes, personal video recorders, TV receivers, loudspeakers, and others, can readily employ embodiments of the present invention. In addition to home appliances, data servers, web servers, databases, or other service providing components can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a universal identity element (UIM) 38. The UIM 38 is typically a memory device having a processor built in. The UIM 38 may include, for example, a subscriber identity element (SIM), a universal integrated circuit card (UICC), a universal subscriber identity element (USIM), a removable user identity element (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

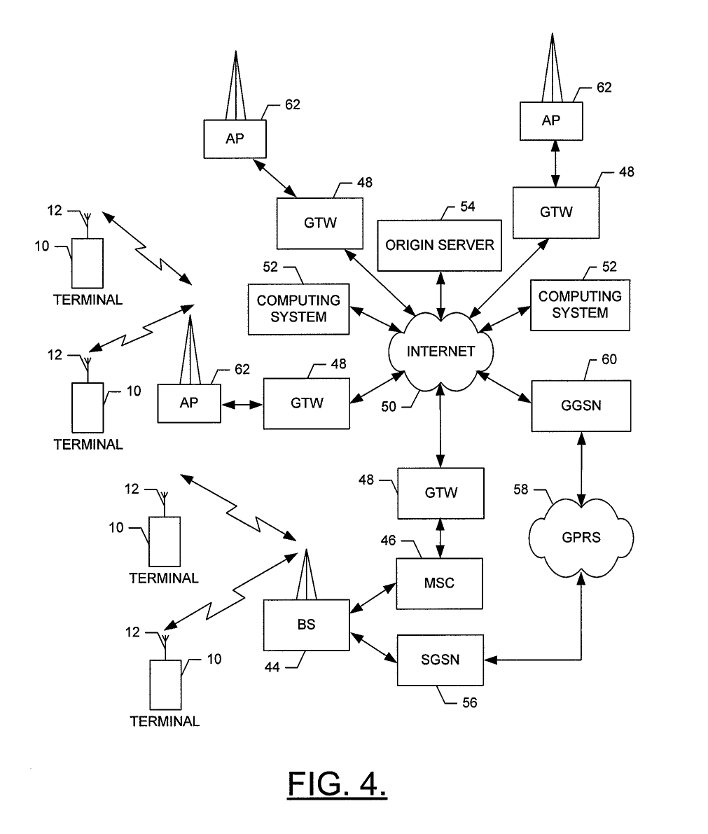

Referring now to FIG. 4, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 4, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 4), origin server 54 (one shown in FIG. 4) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11 g, 802.1 In, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 4, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

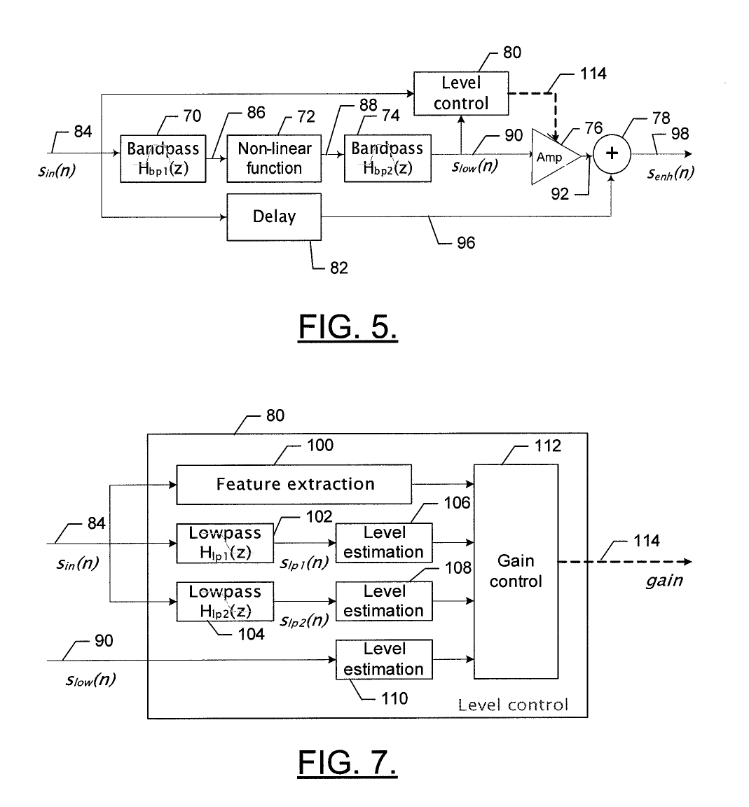

An exemplary embodiment of the invention will now be described with reference to FIG. 5, in which certain elements of a system for providing low frequency expansion of speech are displayed. The system of FIG. 5 may be employed, for example, on the mobile terminal 10 of FIG. 3 embodied as a low frequency expansion algorithm. However, it should be noted that the system of FIG. 5, may also be employed on a variety of other devices, both mobile and fixed, and therefore, embodiments of the present invention should not be limited to application on devices such as the mobile terminal 10 of FIG. 3. Thus, although FIG. 5 and subsequent figures will be described in terms of a system for providing low frequency expansion which is employed on a mobile terminal, it will be understood that such description is merely provided for purposes of explanation and not of limitation. Moreover, the system for providing low frequency expansion could be embodied in a standalone device or a computer program product and thus, the system of FIG. 5 need not actually be employed on any particular device. It should also be noted, that while FIG. 5 illustrates one example of a configuration of a system for low frequency expansion, numerous other configurations may also be used to implement embodiments of the present invention.

Referring now to FIG. 5, a system for providing low frequency expansion of speech is provided. The system includes a first band-pass filter 70, a non-linear function 72, a second band-pass filter 74, an amplifying element 76, a summing element 78, a level control element 80 and a delay element 82. The first band-pass filter 70 receives an input speech signal 84 as an input and performs a band-pass filtration of the input speech signal 84. The pass band of the first band-pass filter 70 is selected to ensure that two or more harmonic components of the input speech signal 84 are passed as a first filtered signal 86. It should be understood that in an exemplary embodiment the input speech signal 84 may be a narrowband speech signal having a typical narrowband frequency range of about 300 Hz to about 3400 Hz. Alternatively, the input speech signal 84 could be a high frequency expanded narrowband speech signal having a frequency range from about 300 Hz to about 7 or 8 kHz. As such, although the descriptions herein will largely be directed to low frequency expansion of signals to recover lost harmonics from a frequency range of about 50 Hz to about 300 Hz, embodiments of the present invention may be practiced for recovery of low frequency harmonics in any frequency range. Each of the elements described above may be embodied as any means or device embodied in hardware, software or a combination of hardware and software, which is capable of performing the corresponding functions associated with each of the elements as described in greater detail below. In an exemplary embodiment, the above elements may each be embodied in software as a low frequency expansion algorithm comprising instructions that may be stored, for example, in a memory of the mobile terminal 10 of FIG. 3.

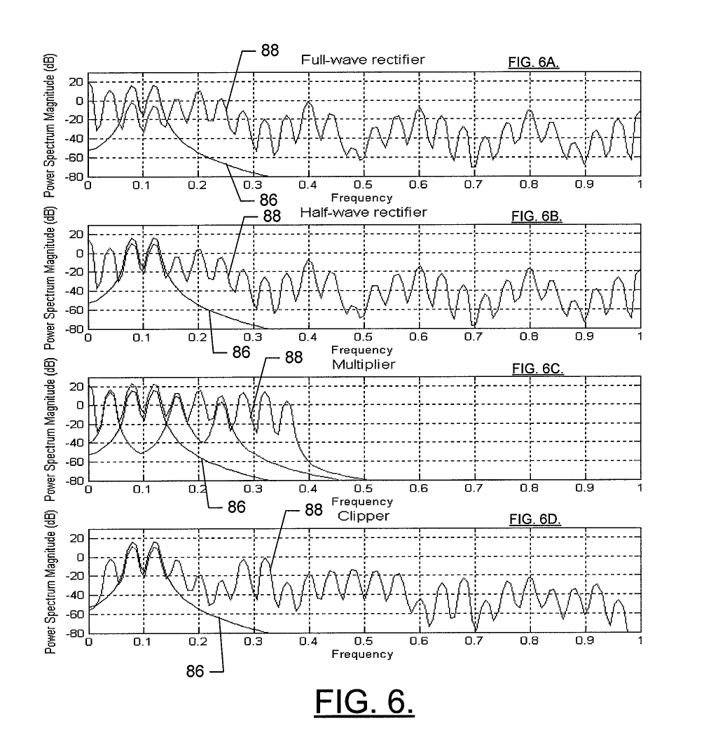

The first filtered signal 86 may be communicated to the non-linear function 72 which is in communication with the first band-pass filter 70. The non-linear function 72 creates low frequency components at harmonics below those included in the input speech signal 84. In this regard, the non-linear function 72 may create either or both of the fundamental frequency and other low frequency harmonics. For example, if the first band-pass filter 70 includes a pass band that passes the first and second harmonics of a particular input speech signal, the non-linear function 72 may produce the fundamental frequency and other harmonics as an output as shown in FIG. 6. It should be noted that, as seen in FIG. 6, embodiments of the present invention may create high frequency harmonics in addition to low frequency harmonics such as the fundamental frequency.

FIG. 6 shows examples in which the input speech signal 84 has been filtered at the first band-pass filter 70 to produce the first filtered signal 86 including the first and second harmonics which is processed by several exemplary non-linear functions. Examples of non-linear functions that may be employed as the non-linear function 72 of FIG. 5 and those following may include a full wave rectifier (see FIG. 6A), a half-wave rectifier (see FIG. 6B), a multiplier (see FIG. 6C) and a clipper (see FIG. 6D). It should be noted that although the first filtered signal 86 is shown to include only the first and second harmonics in FIG. 6, the first filtered signal 86 could also or alternatively include other harmonic components. It should also be noted that the non-linear functions listed above and shown in FIG. 6 are not the only non-linear functions that may be employed in embodiments of the present invention. In this regard, the non-linear functions shown and described in reference to FIG. 6 are provided merely for exemplary purposes and not for purposes of limitation.

As stated above, the non-linear function 72 is employed to recreate missing and/or attenuated harmonic components from the input speech signal 84 using the existing harmonics from the input speech signal 84. The missing and/or attenuated harmonic components are recoverable using the non-linear function 72 since, when a non-linear function is applied to a signal with two or more sine components (i.e., harmonics), the non-linear function produces some upper harmonic components and intermodular components at sum and difference frequencies of the two or more sine components. As shown in FIG. 6, some exemplary non-linear functions include a full-wave rectifier (absolute value of the signal), a half-wave rectifier (negative samples set to zero), a multiplier (signal raised to some power), and a clipper (largest amplitudes are clipped). The above and other non-linear functions may be employed either alone or in combination within the non-linear function 72.

In an exemplary embodiment as shown in FIG. 6C, where the first filtered signal 86 includes the first and second harmonic components (f₁ and f₂), but the fundamental frequency (f₀) is missing, the multiplier embodiment in which the first filtered signal 86 is raised to the power of 2 would produce the following output:

$$\begin{matrix}{( sin {ω}_{1} + sin {ω}_{2} )}^{2} = {sin}^{2} {ω}_{1} + {sin}^{2} {ω}_{2} + 2 sin {ω}_{1} sin {ω}_{2} \\ = 1 - \frac{1}{2} cos 2 {ω}_{1} - \frac{1}{2} cos 2 {ω}_{2} + cos ( {ω}_{1} - {ω}_{2} ) - \\ cos ( {ω}_{1} + {ω}_{2} ) \\ = 1 - \frac{1}{2} cos {ω}_{3} - \frac{1}{2} cos {ω}_{5} + cos {ω}_{0} - cos {ω}_{4}\end{matrix}$$

where ω₀2πf₀, ω₁=2πf₁, ω₂=2πf₂, etc, and f₁=2f₀,f₂=3f₀, etc. Thus, a non-linear function output 88 from the non-linear function 72 would contain the lost fundamental frequency and the 3^{rd}, 4^{th}, and 5^{th} harmonic components as shown in FIG. 6C. Examples of similar cases for all other nonlinearities listed above are shown in FIGS. 6A, 6B and 6D. In each of the cases, the spectrum of the first filtered signal 86 includes the first two harmonics (f₁ and f₂) and the non-linear function output 88 of each non-linearity is plotted to be superimposed over the first filtered signal 86.

As stated above, the first filtered signal 86 which is input to the non-linear function 72 may be a band-pass filtered version of the signal to be expanded (i.e. the input speech signal 84). The pass band H_{bp1}(z) of the first band-pass filter 70 may be fixed or dependent on the fundamental frequency of the input speech signal 84. In other words, filters employed in embodiments of the present invention may be either signal dependent or signal independent. For example, if the pass band of the first band-pass filter 70 is fixed (i.e., signal independent), the pass band should be such that at least two harmonics are always preserved, e.g. roughly 100-600 Hz. Meanwhile, if the pass band of the first band-pass filter 70 is dependent on the fundamental frequency of the input speech signal 84 (i.e., signal dependent), the higher cutoff frequency may be selected to be about 2-4 times a value of an estimate of the fundamental frequency.

As shown in FIG. 6, the non-linear function output 88 may include both lower and higher frequency components than those of the first filtered signal 86 and possibly even a zero frequency or direct current (DC) component. Accordingly, the second band-pass filter 74 may be employed to pass only selected low frequency portions of the non-linear function output 88. In this regard, a lower cutoff frequency of the second band-pass filter 74 having a pass band H_{bp2}(z) may be selected such that the fundamental frequency is saved but the DC component introduced by the nonlinear function is filtered out, e.g. about 50-150 Hz. A higher cutoff frequency of the second band-pass filter 74 may correspond to a highest possible lower cutoff frequency of the input speech signal 84 (sᵢₙ(n) in FIG. 5), e.g. about 300-500 Hz. An output of the second band-pass filter 74 may be a second filtered signal 90 which includes low frequency components s_{low}(n), which are within the pass band of the second band-pass filter 74.

The second filtered signal 90 may then be gain adjusted by the amplifying element 76, a gain of which is controlled by the level control element 80 as described in greater detail below. An output of the amplifying element 76 is a gain adjusted low frequency signal 92 which is delayed with respect to the input speech signal 84 due to delays introduced, for example, in the first and second band-pass filters 70 and 74 and the non-linear function 72. The delays introduced may be compensated for before summation of the gain adjusted low frequency signal 92 with the input speech signal 84 at the summing element 78. In this regard, the delay element 82 may be employed to compensate for the delays introduced into the gain adjusted low frequency signal 92 by delaying the input speech signal 84 to produce a delayed input speech signal 96. The delays should be substantially the same throughout the pass band of the second band-pass filter 74, such that generated low-frequency components are summed in-phase with original signal components of the input speech signal 84 that have the same frequencies. In other words, components in the gain adjusted low frequency signal 92 must be summed in phase with corresponding components from the input speech signal 84. If the delay is frequency-dependent, a separate phase equalizer may be employed. If the first and second band-pass filters 70 and 74 are implemented as finite impulse response (FIR) filters and the non-linear function 72 preserves the phase, no phase equalizer may be needed and a constant delay may be used. If infinite impulse response (IIR) filters are used, the phase of the delayed input signal 96 may be equalized with an all pass filter. In any case, the delayed input signal 96 may be summed with the gain adjusted low frequency signal 92 to produce an enhanced or expanded output signal 98 (sₑₙₕ(n) in FIG. 5), which includes the original input speech 84 and recovered frequency components to replace the missing and/or attenuated harmonic components from the input speech signal 84.

As stated above, the amplifying element 76 adjusts a gain of the second filtered signal 90 to produce the gain adjusted low frequency signal 92. The gain of the amplifying element 76 is controlled by the level control element 80. An exemplary embodiment of the level control element 80 is shown in FIG. 7. The level control element 80 may include a feature extraction element 100, a first low pass filter 102, a second low pass filter 104, a first level estimation element 106, a second level estimation element 108, a third level estimation element 110 and a gain control element 112. In this exemplary embodiment, the feature extraction element 100 and the first and second low pass filters 102 and 104 each receive the input speech signal 84 as an input. The first and second low pass filters 102 and 104 may be in communication with the first and second level estimation elements 106 and 108, respectively. The third level estimation element 110 may receive the second filtered output 90 as an input. The feature extraction element 100 and the first, second and third level estimation elements 102, 104 and 106 are each in communication with the gain control element 112 to provide inputs to the gain control element 112, which controls the gain of the amplifying element 76 in response to the inputs.

The level control element 80 is employed to provide an adjustment to low frequency content prior to summing the low frequency content with the delayed input speech signal 96 to produce the expanded output signal 98. Accordingly, the level control element 80 adjusts the gain of the amplifying element 76 in response to a feature of the input speech signal 84. In this regard, a feature vector may be extracted from the input speech signal 84 using a feature extraction element 100. The feature vector may be used as an indicator of how much energy is missing from the input speech signal in the lowest frequencies (i.e., an estimate of the energy of the missing and/or attenuated harmonic components). In an exemplary embodiment, the feature vector may represent a tilt (or slope) of the narrowband spectrum. However, other features may be selected for use as the feature vector such as zero crossing rate or others. The tilt may be estimated from a fast Fourier transform (FFT) spectrum. Alternatively, a first order auto-regressive coefficient may be used.

The level control element 80 calculates signal energies or amplitude levels of three different signals. Two of the three different signals are produced by processing the input speech signal 84 at the first and second low-pass filters 102 and 104. Cutoff frequencies of the first and second low-pass filters 102 and 104 having pass bands Hₗₚ₁(z) and Hₗₚ₂(z), respectively, may be about 300-500 Hz and 500-800 Hz, respectively. Furthermore, the cutoff frequency of the first low-pass filter 102 may be selected to be substantially equal to a higher cutoff frequency of the second low-pass filter 104. Outputs of the first and second low-pass filters 102 and 104 (i.e., sₗₚ₁(n) and sₗₚ₂(n), respectively) are communicated to the first and second level estimation elements 106 and 108, respectively, which determine respective levels of sₗₚ₁(n) and sₗₚ₂(n). A third level estimate for determining a gain signal 114 to be applied to the amplifying element 76 may be a level of the second filtered signal 90 (i.e., s_{low}(n)) that is output from the third level estimation element 110 and is based on low-frequency component regeneration parts generated by the expansion algorithm as provided by the system described with reference to FIG. 5.

The level control element 80 produces the gain signal 114 based on an approximation that describes a relationship between sub-band amplitude levels calculated from a direct narrowband signal (e.g., a signal with original low-frequency components such as the second filtered signal 90), and a feature vector extracted from the corresponding low-frequency limited narrowband signal (e.g., the input speech signal):

$$\frac{{L}_{1}}{{L}_{2}} \approx {f}_{L} ( a )$$

where L₁ is the amplitude level of a direct signal in the frequency band defined by the first low-pass filter 102, L₂ is the amplitude level of a direct signal in the frequency band defined by the second low-pass filter 104, f_{L} is a function that has been previously defined using direct training samples, and a is the feature vector extracted from a corresponding low-frequency limited signal.

Based on the approximation above, the gain to be applied to the second filtered signal 90 at the amplifying element 76 may be calculated as:

$$g = \frac{{f}_{L} ( a ) {L}_{lp2} - {L}_{lp1}}{{L}_{low} ( 1 - {f}_{L} ( a ) )} ,$$

where Lₗₚ₁ is the amplitude level of the bandlimited signal sₗₚ₁(n) (i.e., the output of the first level estimation element 106), Lₗₚ₂ is the amplitude level of a bandlimited signal sₗₚ₂(n) (i.e., the output of the second level estimation element 108), and L_{low} is the amplitude level of signal s_{low}(n) (i.e., the output of the third level estimation element 110).

It should be noted that although FIG. 7 shows level estimation elements for use in determining gain, energy estimation elements may be substituted and energies rather than amplitude levels may be used for determining gain. If energies are used instead of amplitude levels, the corresponding formulas are:

$$\frac{{E}_{1}}{{E}_{2}} \approx {f}_{E} ( a ) ,$$

where E₁ is the energy of a direct signal in the frequency band defined by the first low-pass filter 102, E₂ is the energy of the direct signal in the frequency band defined by the second low-pass filter 104, and f_{E} is a function of the feature vector a. The gain to be applied to the second filtered signal 90 at the amplifying element 76 may be calculated as:

$$g = \frac{\sqrt{{f}_{E} ( a ) E [ {s}_{lp2} ( n ) ]} - \sqrt{E [ {s}_{lp1} ( n ) ]}}{\sqrt{E [ {s}_{low} ( n ) ]} ( 1 - \sqrt{{f}_{E} ( a )} )} ,$$

where E[sₗₚ₁(n)] is the energy of the bandlimited signal sₗₚ₁(n), E[sₗₚ₂(n)] is the energy of the bandlimited signal sₗₚ₂(n) and E[s_{low}(n)] is the energy of s_{low}(n) (i.e., the energy of the second filtered signal 90).

The feature vector could contain several features that could be useful in defining an optimal level adjustment. The features can be all extracted inside the level control element 80 by the feature extraction element 100, in exemplary embodiments in which a level control algorithm which embodies the level control element 80 includes the feature extraction element 100 as shown in FIG. 7. Alternatively, the feature extraction element 100 may be disposed at some other element apart from the level control element 80. For example, the feature extraction element 100 may be disposed at some other speech enhancement algorithm or from a separate speech codec which is in communication with the level control element 80.

In an exemplary embodiment of the invention, an apparatus may be configured to execute the low frequency expansion described above for each input speech signal without regard to other factors. However, in an alternative exemplary embodiment, the low frequency expansion described above may be applied discriminatorily based on information related to device capabilities for devices receiving an input from an apparatus or computer program product capable of providing low frequency expansion as described above. For example, accessory information could be utilized so that low frequency expansion as described above is enabled only when it is determined that speaker elements being used are able to reproduce the generated low-frequency components. Additionally or alternatively, volume information could be also be useful in determining whether the low frequency expansion as described above should be employed due to potential limited power tolerance of earpiece elements. Alternatively, an amount of expansion towards low frequencies could be programmed to decrease gradually as the volume increases. In addition, a noise level of the input speech signal 84 may affect performance. Thus, when the signal-to-noise ratio (SNR) is poor, less content may be added to the low frequencies, because intelligibility may suffer if the noise components are expanded also.

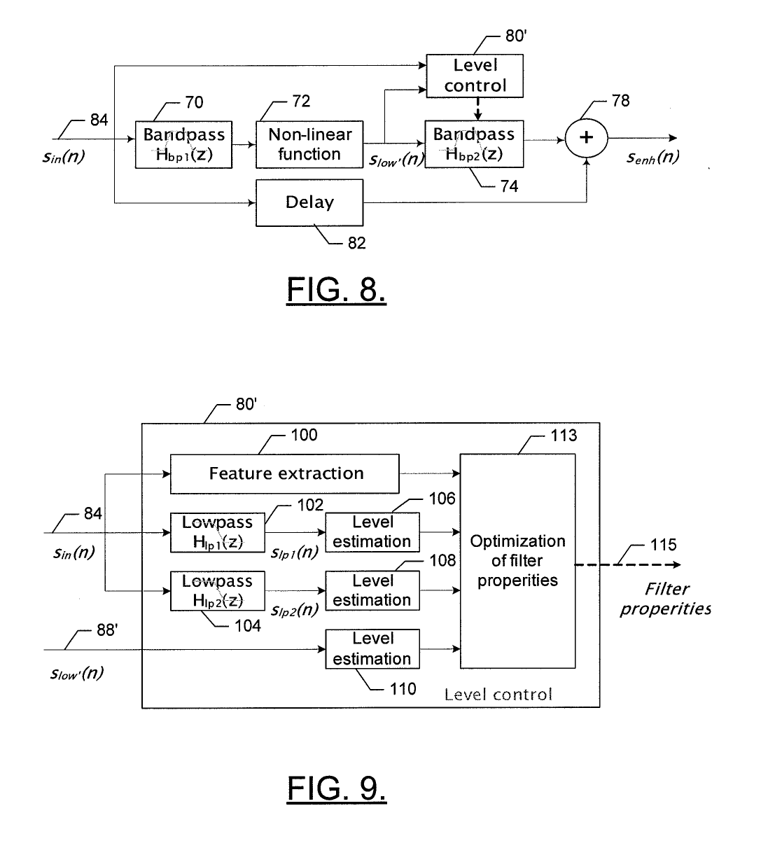

It should also be noted that it is possible to directly control the properties of filter elements rather than providing a separate gain control for the output of the filter elements. For example, as shown in FIG. 8, a level control element 80′ may be employed to directly control or optimize the properties of the second band-pass filter 74. It should be noted that the exemplary embodiment of FIG. 8 is substantially similar to that of FIG. 5 except that instead of controlling an amplification of the second filtered signal 90, an output of the non-linear function 88′ is input into the level control element 80′ for employment in optimization of the filter properties of the second band-pass filter 74. FIG. 9 shows a more detailed view of an exemplary embodiment of the level control element 80′, which may be used to directly control filter element properties. The exemplary embodiment of FIG. 9 is substantially similar to that of FIG. 7, except that the non-linear function output 88′ is used for level estimation and the level estimations and the extracted feature are input into an optimization element 113, which outputs filter properties 115 for input into the second band-pass filter 74 to optimize the filter properties of the second band-pass filter 74 thereby making level control of a separate gain element unnecessary. It should be further noted that control of filter properties could also include control of gain properties. In this regard, the amplifying element 76 could be a portion of the second band-pass filter 74 and thus, controlling filter properties could include controlling gain properties.

Processes described above for providing low frequency expansion of an input speech signal may also be employed in a downsampled (or decimated) time domain. A low frequency expansion algorithm, such as that described above, is characterized in that an output of the algorithm includes the input speech signal 84 relatively unchanged except that an expanded low frequency component is added to the input speech signal 84. As such, low frequency expansion is a good candidate for processing using multi-rate signal processing techniques. In this regard, it is conceivable that significant computational savings could be achieved by splitting the input speech signal 84 into two or more downsampled signals and then implementing low frequency expansion only on the lowest frequency region.

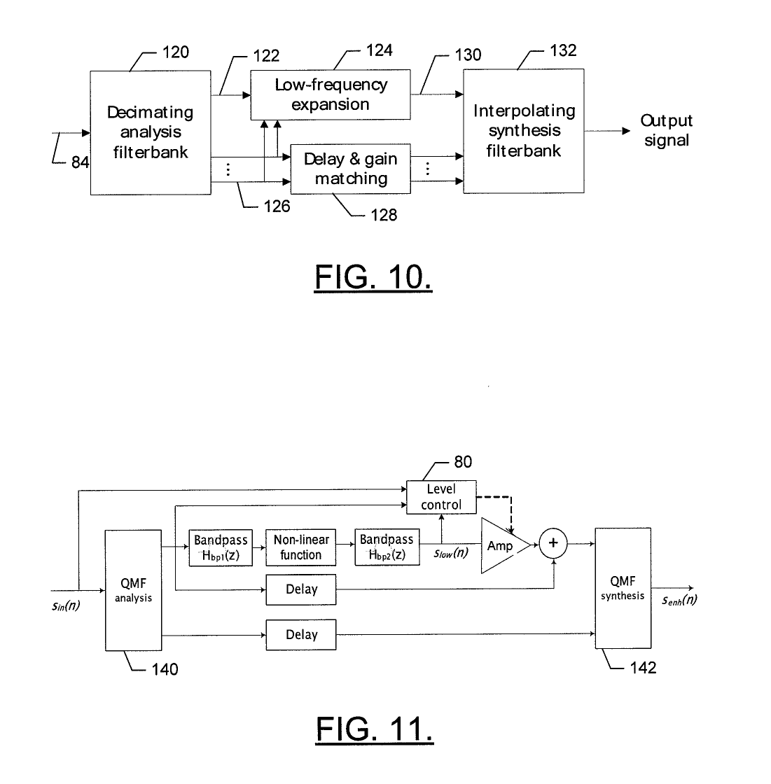

FIG. 10 shows an exemplary embodiment in which downsampling may be practiced upon the input speech signal 84 prior to implementing the low frequency expansion described above. As shown in FIG. 10, a decimating analysis filterbank 120 may be employed to divide the input speech signal 84 into separate frequency bands. A low frequency band 122 may then be input into a low frequency expansion element 124, which employs low frequency expansion as described above. One or more high frequency bands 126 may then be communicated to a delay and gain matching element 128, which inserts any delay and/or gain that may be desired to prepare the one or more high frequency bands 126 for recombination with a low frequency expanded signal 130 at an interpolating synthesis filterbank 132. Low frequency expansion benefits from decimation because processing affects only signal components under roughly 500 Hz, which is considerably lower than a bandwidth of most narrow-band speech input signals.

Downsampling time domain processing helps in reducing the computational complexity in two main ways. First, all processing operations can be done at a lower sampling rate (i.e., less frequently). Accordingly, there is a savings in processor cycles which is linearly related to the downsampling factor. Second, without downsampling, the digital filters required in this application have fairly low cutoff frequencies and sharp transition bands, which require fairly high order, computationally accurate filters. Because the relative cutoff frequencies and transition bands increase with decreasing sampling rate, lower order filters can be used in a downsampled implementation. If filters are implemented as FIR filters, the filter length normally has a direct relation to the transition bandwidth. Additionally, when processing decimated signals, issues related to computational accuracy pertinent to IIR filter implementations are much less critical. As a result, downsampling may result in linear savings in computational complexity, which decreases with the sampling rate. However, consideration must also be given to overhead that is added by analysis and synthesis filterbanks.

An exemplary implementation of decimation may be accomplished using quadrature mirror filters (QMF) as shown in FIG. 11. FIG. 11 shows an implementation that is substantially similar to the implementation shown in FIG. 10, except that the decimating analysis filterbank 120 is embodied as a QMF analysis element 140 and the synthesis filterbank 132 is embodied as a QMF synthesis element 142. As shown in FIG. 11, the low frequency expansion algorithm of FIG. 5 may be employed as the low frequency expansion element 124 of FIG. 10.

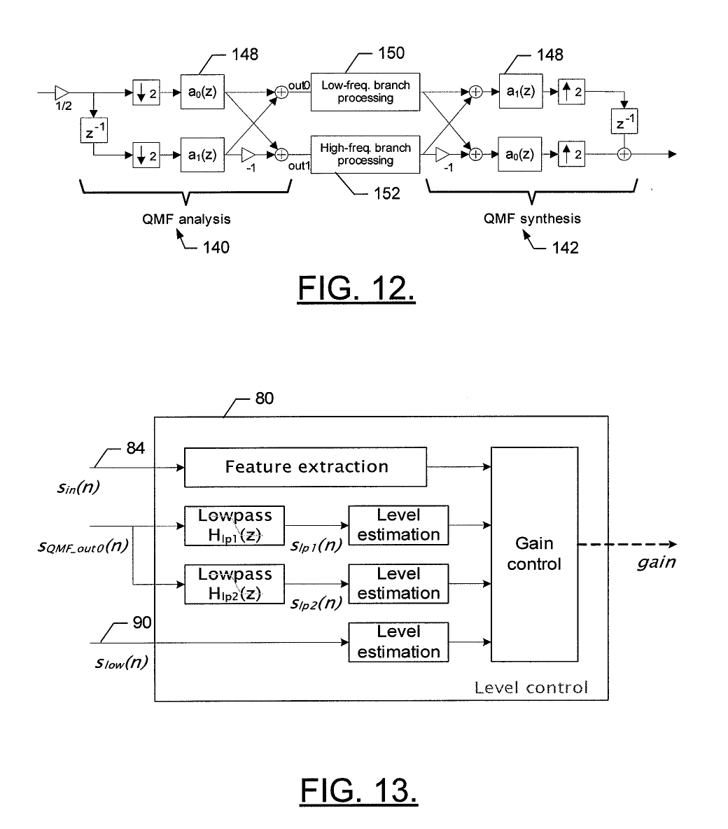

A more detailed example showing the QMF analysis element 140 and the QMF synthesis element 142 is illustrated in FIG. 12. As shown in FIG. 12, four all-pass filters 148 (i.e. two of each type of filter having characteristics a₀(z) and a₁(z)) may be employed, which operate at one half of the full sampling rate. In this exemplary embodiment, one separate instance of identical filter elements a₀(z) and a₁(z) are employed in each of the QMF analysis element 140 and the QMF synthesis element 142, respectively. A few other primitive operations such as additions, subtractions and delays are also employed in the QMF elements of FIG. 12. An example of specific filter designs for a₀(z) and a₁(z)) may be, for example,

$${a}_{0} ( z ) = \frac{0.024461 + 0.5153 {z}^{- 1} + {z}^{- 2}}{1 + 0.5153 {z}^{- 1} + 0.024461 {z}^{- 2}}$$

$${a}_{1} ( z ) = \frac{0.16761 + 1.0037 {z}^{- 1} + {z}^{- 2}}{1 + 1.0037 {z}^{- 1} + 0.16761 {z}^{- 2}} .$$

The QMF analysis element 140 splits the input speech signal 84 into a low-frequency portion (i.e., out0) and a high-frequency portion (i.e., out1) which undergo respective low-frequency branch processing 150 and high-frequency branch processing 152 as shown in FIG. 12. The low-frequency branch processing 150 may include, for example, processing as described above with respect to the low frequency expansion element 124 of FIG. 10. Meanwhile, the high-frequency branch processing 152 may include delay and gain matching as shown, for example, in FIG. 10.

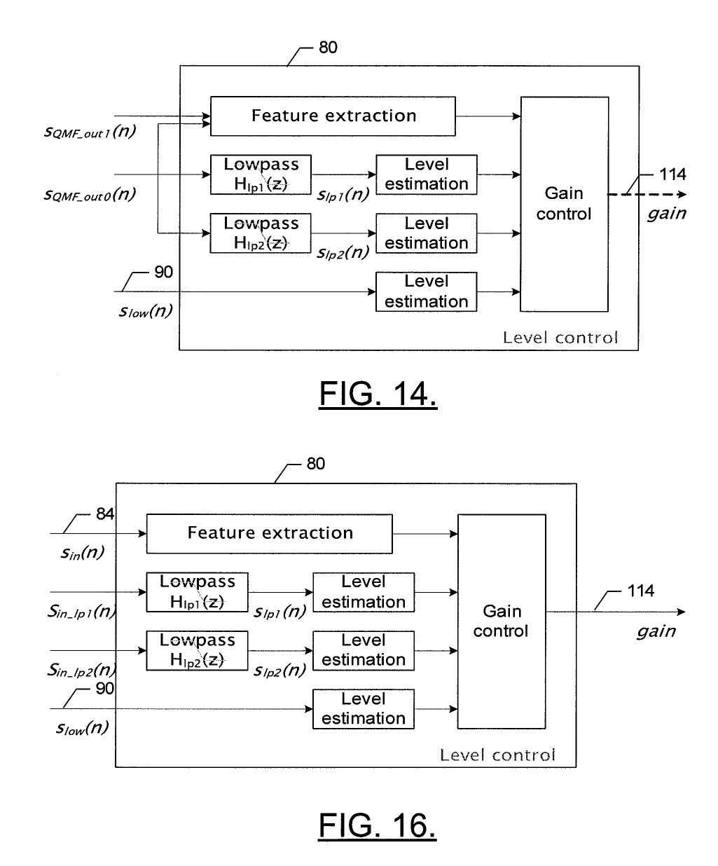

It should be noted that both the low and high-frequency branch processing 150 and 152 may also include use of the low and high-frequency portions (out0 and out1, respectively) in level control operations. More specifically, inputs to the level control element 80 may be modified as shown in FIGS. 13 and 14 to incorporate signals from the QMF analysis element 140 corresponding the out0 and out1 (see S_{QMF}_{_{—}}out0 and S_{QMF}_{_{—}}out1, respectively). It should be noted that the level control element 80 of FIGS. 13 and 14 is substantially the same as shown in FIG. 7 except that the inputs to the level control element 80 may be changed. In this regard, FIG. 13 illustrates an exemplary embodiment of the level control element 80 in which the input speech signal 84 is used for feature extraction, but an output of the QMF analysis element 140 corresponding to the low-frequency portion (i.e., S_{QMF}_{_{—}}out0) is input into both the first and second low-pass filters 102 and 104. Meanwhile, FIG. 14 illustrates an exemplary embodiment of the level control element 80 in which outputs of the QMF analysis element 140 corresponding to both the low and high-frequency portions (i.e., S_{QMF}_{_{—}}out0 and S_{QMF}_{_{—}}out1) are used for feature extraction, but only the low-frequency portion (i.e., S_{QMF}_{_{—}}out0) is input into both the first and second low-pass filters 102 and 104. In other words, for example, the relative signal levels in the two branches could be used as a feature. Thus, the feature may be extracted from the input speech signal 84 directly, or from other signals associated with the input speech signal 84.

Both the low and high-frequency portions represent critically downsampled data. Because filters can never have infinitely sharp transition bands and infinite stopband attenuation, the analysis process will always produce aliased signal components (i.e., original components in the higher frequency band will cause attenuated signal components in the low-frequency output). However, the framework shown in FIG. 12 is designed so that the aliased components will cancel out from the resynthesized output if no processing is done to the decimated signals, or if the processing is matched such that phase and magnitude responses are identical in the two branches.

Of course, when the low-frequency band from the QMF analysis element 140 is processed for low-frequency extension, the phase and magnitude responses in the two branches will not be the same. Adding energy to the low-frequency signal components will create spurious high-frequency components when signals are reconstructed in the QMF synthesis element 142. However, this is not a problem in practice as long as the responses can be matched for the QMF transition band frequency region, where the aliasing is the strongest. For low-frequency extension of speech signals, this is easily achieved, as the low-frequency region where energy is added is sufficiently far from a typical QMF transition band edge. In such a case, a magnitude of generated aliased high-frequency components is determined by a stopband attenuation in the QMF synthesis element 142.

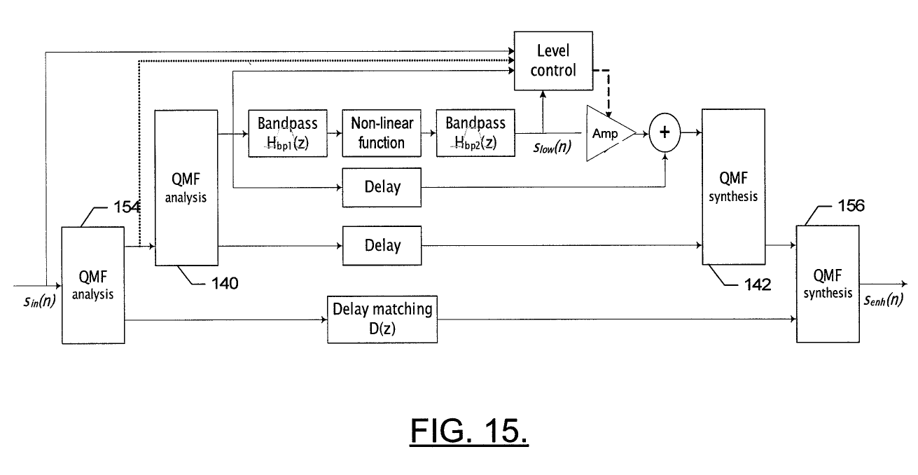

If an original sampling rate of the input speech signal 84 is, for example, 8 kHz, applying QMF downsampling once enables running time-domain processing at a 4 kHz sampling rate with an effective frequency range between about 0 and 2 kHz. Considering the frequency ranges of the filters employed, it may be possible to process data decimated by an additional factor of two. Such an implementation may be achieved by wrapping the implementation described with respect to FIG. 11, which may be referred to as an inner framework, in an outer framework including a second QMF analysis element 154 and a second QMF synthesis element 156 as shown in FIG. 15. In this regard, the QMF analysis element 140 and the QMF synthesis element 142 may form a first pair of QMF filters, while the second QMF analysis element 154 and the second QMF synthesis element 156 for a second pair of QMF filters. The second pair of QMF filters is “wrapped” around the first pair of QMF filters such that the input of the QMF analysis element 140 is communicated from the output of the second QMF analysis element 154 and the output of the QMF synthesis element 142 is communicated to the input of the second QMF synthesis element 156. A delay matching D(z) in the high-frequency branch of the outer QMF framework may be configured to take into account a group delay introduced into the low-frequency branch by the inner framework.

Accordingly, in the case of dual downsampling as shown in FIG. 15, input signals for the level control element 80 may be taken either from the 4 kHz (decimated by two) or the 2 kHz (decimated by four) domain as shown in FIG. 16. In this regard, input signal sᵢₙ_{_{—}}ₗₚ₁(n) can be taken from the lowest-frequency domain of the inner framework, but the cutoff frequency of the second low-pass filter 104 may be so close to the Nyquist frequency of the lowest domain that it may be advisable to take input signal sᵢₙ_{_{—}}ₗₚ₂(n) from the low-frequency branch of the outer framework. For a case, where the cutoff frequencies of the first and second low-pass filters 102 and 104 are in octave relation, e.g., 300 Hz and 600 Hz, respectively, filtering could be implemented such that the same filter design is used for both filters, and both filters are operated on different sampling rates. Accordingly, there may be a reduction in memory used for storing filter coefficients, because only one set of filter coefficients would be needed. If the first and second low-pass filters 102 and 104 are run at the same sampling rate, an octave relation between the cutoff frequencies could be utilized by designing a filter for the lower cutoff frequency, and using every second coefficient to realize filtering by the other filter.

As stated above, embodiments of the present invention may be employed in numerous fixed and mobile devices. It should be noted, however, that when embodiments are implemented in mobile telephone networks, such embodiments may be implemented in either mobile terminals or network side devices. For example, embodiments of the present invention may be implemented in a mobile terminal with a digital signal processor (DSP) together with other speech enhancement algorithms. Meanwhile, embodiments implemented in a network side device may be used on decoded speech signals. As such, input may be received from terminals which transmit narrowband signals and signals having low frequency expansion may be provided to mobile terminals in communication with the network side device. In this regard, low frequency expansion services may be provided in conjunction with high frequency expansion services or any other service either to every customer or to particular customers.

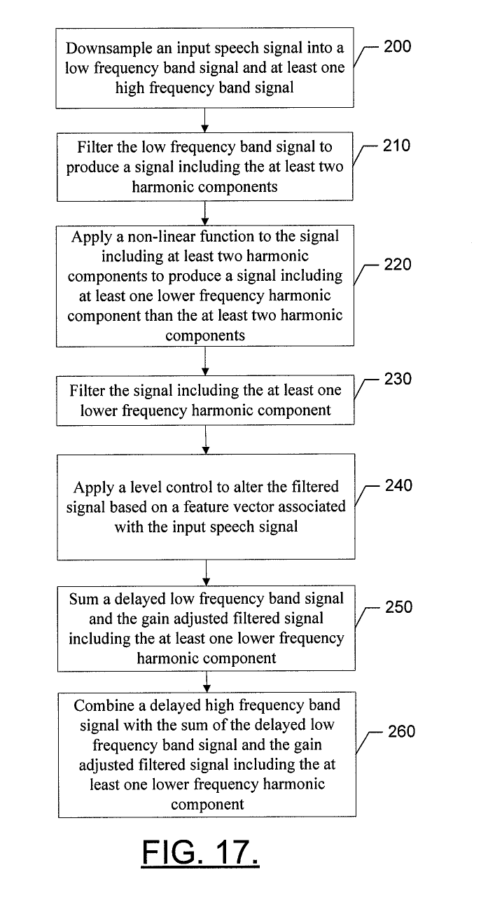

FIG. 17 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing low frequency expansion of speech, as shown in FIG. 16, may include an optional initial operation of downsampling an input speech signal into a low frequency band signal and at least one high frequency band signal at operation 200. Either a lowest frequency band of the downsampled signal, or if downsampling is not performed, the input speech signal is filtered to extract at least two harmonic components at operation 210. Filtering at operation 210 is performed by a first band-pass filter. At operation 220, a non-linear function is applied to the at least two harmonic components to produce at least one harmonic component having a lower frequency than a highest frequency harmonic of the two harmonic components. It should be noted that the at least one harmonic component having the lower frequency than the two harmonic components that is produced at operation 220 may be, for example, a creation of a previously missing lower frequency harmonic or an amplification of a previously attenuated lower frequency harmonic. Furthermore, in one exemplary embodiment, the two harmonic components may be an attenuated version of the fundamental frequency and the first harmonic. Accordingly, the output of the non-linear function (i.e., the at least one lower frequency harmonic component) would be a reinforced or amplified version of the previously attenuated version of the fundamental frequency. At operation 230, an output of the non-linear function is filtered to remove frequency components that are either too high or too low in frequency to be beneficial. Components are too low if they are below a frequency that is audible to humans or below a frequency that a speaker element of an output device can reproduce effectively. Components are too high if they are components present in the input speech signal. At operation 240, a level control is applied to alter the filtered signal based on a feature vector associated with an input speech signal. The level control may be an adjustment to filter properties such as a gain adjustment or other filter property adjustment. At operation 250, a delayed low frequency band signal (or a delayed input speech signal if no downsampling was performed) is summed with the gain adjusted filtered signal including the at least one lower frequency harmonic component. At optional operation 260, a delayed high frequency band signal may be recombined with the sum of the delayed low frequency band signal and the gain adjusted filtered signal including the at least one lower frequency harmonic component.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
applying a non-linear function to a signal including at least two harmonic components to produce a signal including at least one lower frequency harmonic component having a lower frequency than a highest frequency component of the at least two harmonic components;
filtering the signal including the at least one lower frequency harmonic component; and
applying a level control to alter the filtered signal based on a feature vector associated with an input speech signal.

2. A method according to claim 1, further comprising an initial operation of filtering the input speech signal to produce the signal including the at least two harmonic components.

3. A method according to claim 2, further comprising summing a delayed input speech signal and the gain adjusted filtered signal including the at least one lower frequency harmonic component.

4. A method according to claim 1, further comprising:
an initial operation of downsampling the input speech signal into a low frequency band signal and at least one high frequency band signal; and
filtering the low frequency band signal to produce the signal including the at least two harmonic components.

5. A method according to claim 4, further comprising:
summing a delayed low frequency band signal and the gain adjusted filtered signal including the at least one lower frequency harmonic component; and
combining a delayed high frequency band signal with the sum of the delayed low frequency band signal and the gain adjusted filtered signal including the at least one lower frequency harmonic component.

6. A method according to claim 2, wherein applying the level control is performed responsive to:
a level estimation of the filtered signal including the at least one lower frequency harmonic component;
the feature vector;
a level estimation of a first low pass band signal; and
a level estimation of a second low pass band signal.

7. A method according to claim 6, wherein applying the level control comprises applying a gain adjustment to the filtered signal including the at least one lower frequency harmonic component based on the feature vector associated with the input speech signal, and
wherein filtering the signal comprises filtering using a filter having time-independent properties.

8. A method according to claim 6, further comprising determining the first and second low pass band signals by low pass filtering the input speech signal using corresponding first and second low pass filters.

9. A method according to claim 5, further comprising:
an initial operation of downsampling the input speech signal into a low frequency band signal and at least one high frequency band signal; and
filtering the low frequency band signal to produce the signal including the at least two harmonic components; and
determining the first and second low pass band signals by low pass filtering the low frequency band signal using corresponding first and second low pass filters.

10. A method according to claim 9, wherein the downsampling and combining operations are each performed using respective quadrature mirror filters of a first pair of quadrature mirror filters.

11. A method according to claim 10, further comprising employing a second pair of quadrature mirror filters wrapped around the first pair of quadrature mirror filters for increasing the downsampling rate by a factor of two.

12. A method according to claim 6, wherein applying the level control comprises controlling filter properties based on a feature vector associated with the input speech signal.

13. A computer program product comprising at least one computer-readable storage medium having computer-readable program code portions stored therein, the computer-readable program code portions comprising:
a first executable portion for applying a non-linear function to a signal including at least two harmonic components to produce a signal including at least one lower frequency harmonic component having a lower frequency than a highest frequency component of the at least two harmonic components;
a second executable portion for filtering the signal including the at least one lower frequency harmonic component; and
a third executable portion for applying a level control to alter the filtered signal based on a feature vector associated with an input speech signal.

14. A computer program product according to claim 13, further comprising a fourth executable portion for an initial operation of filtering an input speech signal to produce the signal including the at least two harmonic components.

15. A computer program product according to claim 14, further comprising a fifth executable portion for summing a delayed input speech signal and the gain adjusted filtered signal including the at least one lower frequency harmonic component.

16. A computer program product according to claim 13, further comprising:
a fourth executable portion for an initial operation of downsampling the input speech signal into a low frequency band signal and at least one high frequency band signal; and
a fifth executable portion for filtering the low frequency band signal to produce the signal including the at least two harmonic components.

17. A computer program product according to claim 16, further comprising:
a sixth executable portion for summing a delayed low frequency band signal and the gain adjusted filtered signal including the at least one lower frequency harmonic component; and
a seventh executable portion for combining a delayed high frequency band signal with the sum of the delayed low frequency band signal and the gain adjusted filtered signal including the at least one lower frequency harmonic component.

18. A computer program product according to claim 14, wherein the third executable portion includes instructions for applying the level control responsive to:
a level estimation of the filtered signal including the at least one lower frequency harmonic component;
the feature vector;
a level estimation of a first low pass band signal; and
a level estimation of a second low pass band signal.

19. A computer program product according to claim 18, wherein the third executable portion includes instructions for applying a gain adjustment to the filtered signal including the at least one lower frequency harmonic component based on the feature vector associated with the input speech signal, and
wherein the second executable portion includes instructions for filtering the signal using a filter having time-independent properties.

20. A computer program product according to claim 18, further comprising a fifth executable portion for determining the first and second low pass band signals by low pass filtering the input speech signal using corresponding first and second low pass filters.

21. A computer program product according to claim 18, further comprising:
a fifth executable portion for an initial operation of downsampling the input speech signal into a low frequency band signal and at least one high frequency band signal; and
a sixth executable portion for filtering the low frequency band signal to produce the signal including the at least two harmonic components; and
a seventh executable portion for determining the first and second low pass band signals by low pass filtering the low frequency band signal using corresponding first and second low pass filters.

22. A computer program product according to claim 21, further comprising an eighth executable portion for combining a delayed high frequency band signal with a sum of a delayed low frequency band signal and a gain adjusted filtered signal including the at least one lower frequency harmonic component, and
wherein the fifth and eight executable portions are each performed using respective quadrature mirror filters of a first pair of quadrature mirror filters.

23. A computer program product according to claim 21, further comprising a ninth executable portion for increasing the downsampling rate by a factor of two using a second pair of quadrature mirror filters wrapped around the first pair of quadrature mirror filters.

24. A computer program product according to claim 18, wherein the third executable portion includes instructions for controlling filter properties based on the feature vector associated with the input speech signal.

25. An apparatus comprising:
a non-linear function element configured to receive a signal including at least two harmonic components and to produce a signal including at least one lower frequency harmonic component having a lower frequency than a highest frequency component of the at least two harmonic components responsive to the signal including at least two harmonic components;
a band-pass filter element in communication with the non-linear function element and configured to filter the signal including the at least one lower frequency harmonic component; and
a level control element configured to apply a level control to alter the filtered signal based on a feature vector associated with an input speech signal.

26. An apparatus according to claim 25, further comprising an input band-pass filter element in communication with the non-linear function element and configured to filter an input speech signal to produce the signal including the at least two harmonic components.

27. An apparatus according to claim 26, further comprising a summing element configured to sum a delayed input speech signal and the gain adjusted filtered signal including the at least one lower frequency harmonic component.

28. An apparatus according to claim 27, further comprising a downsampling analysis element configured to divide the input speech signal into a low frequency band signal and at least one high frequency band signal.

29. An apparatus according to claim 28, further comprising an input band-pass filter element for receiving the low frequency band signal and configured to filter the low frequency band signal to produce the signal including the at least two harmonic components for communication of the signal including the at least two harmonic components to the non-linear function element.

30. An apparatus according to claim 29, further comprising a summing element for summing a delayed low frequency band signal and the gain adjusted filtered signal including the at least one lower frequency harmonic component.

31. An apparatus according to claim 30, further comprising a synthesis filterbank configured to combine a delayed high frequency band signal with the sum of the delayed low frequency band signal and the gain adjusted filtered signal including the at least one lower frequency harmonic component.

32. An apparatus according to claim 31, wherein the level control element comprises:
a first level estimation element for estimating a level of the filtered signal including the at least one lower frequency harmonic component;
a feature extractor for extracting the feature vector;
a second level estimation element for estimating a level of a first low pass band signal; and
a third level estimation element for estimating a level of a second low pass band signal.

33. An apparatus according to claim 32, further comprising:
a first low pass filter for producing the first low pass band signal based on the low frequency band signal; and
a second low pass filter for producing the second low pass band signal based on the low frequency band signal.

34. An apparatus according to claim 26, wherein the level control element comprises:
a first level estimation element for estimating a level of the filtered signal including the at least one lower frequency harmonic component;
a feature extractor for extracting the feature vector;
a second level estimation element for estimating a level of a first low pass band signal; and
a third level estimation element for estimating a level of a second low pass band signal.

35. An apparatus according to claim 34, further comprising:
a first low pass filter for producing the first low pass band signal based on the input speech signal; and
a second low pass filter for producing the second low pass band signal based on the input speech signal.

36. An apparatus according to claim 34, wherein the level control element further comprises a gain control element in communication with the feature extractor and the first, second and third level estimation elements, the gain control element being configured to determine a gain adjustment and apply the gain adjustment to the filtered signal including the at least one lower frequency harmonic component based on the feature vector associated with the input speech signal, and
wherein the band pass filter element is embodied in a filter having time-independent properties.

37. An apparatus according to claim 34, wherein the level control element further comprises an optimization element in communication with the feature extractor and the first, second and third level estimation elements, the optimization element being configured to determine a property adjustment and apply the property adjustment to the band-pass filter element based on the feature vector associated with the input speech signal.

38. An apparatus according to claim 31, wherein the analysis filterbank and the synthesis filterbank are each embodied as respective quadrature mirror filters of a first pair of quadrature mirror filters.

39. An apparatus according to claim 38, further comprising a second pair of quadrature mirror filters wrapped around the first pair of quadrature mirror filters for increasing the downsampling rate by a factor of two.

40. An apparatus according to claim 25, wherein the apparatus is embodied in one of a mobile terminal or a network side device.

41. An apparatus according to claim 25, wherein the non-linear function comprises at least one of:
a full-wave rectifier;
a half-wave rectifier;
a multiplier; and
a clipper.

42. An apparatus according to claim 25, wherein the non-linear function element is configured to produce the signal including at least one lower frequency harmonic component than the at least two harmonic components based on information related to capabilities of the apparatus.

43. An apparatus comprising:
means for applying a non-linear function to a signal including at least two harmonic components to produce a signal including at least one lower frequency harmonic component having a lower frequency than a highest frequency component of the at least two harmonic components;
means for filtering the signal including the at least one lower frequency harmonic component; and
means for applying a level control to alter the filtered signal based on a feature vector associated with an input speech signal.
